(19) United States
(12) Patent Application Publication
(10) Pub. No.: US 2008/0274017 A1
(43) Pub. Date: Nov. 6, 2008

(54) SYSTEM FOR THE PRODUCTION OF SYNTHETIC FUELS

(76) Inventors: Jack W. Boykin, Montrose, AL (US); Allen W. Boykin, Daphne, AL (US)

Correspondence Address: Husch Blackwell Sanders, LLP;Welsh & Katz, 120 S RIVERSIDE PLAZA, 22ND FLOOR, CHICAGO, IL, 60606, US

(21) Appl. No.: 11/768,057

(22) Filed: Jun. 25, 2007

Related U.S. Application Data
(60) Provisional application No. 60/927,552, filed on May 4, 2007.

(51) Int. Cl. B01J 19/02

(52) U.S. Cl. 422/105

(57) ABSTRACT

A system is provided for producing synthetic fuels. A feedstock containing polymers from a wide variety of sources is re-formed into a more satisfactory fuel source in one or more reactors. The reactor can be tube shaped and have an internal auger. The reactor can be non vertical, preferably horizontal. It can include electrical heating elements and can control both temperature and time of reaction. Feedstocks in accordance with the invention can include a wide variety of sources of cellulose or scrap plastic and tires. The process can be environmentally friendly, producing no net greenhouse gases.

### CROSS REFERENCE TO RELATED APPLICATIONS

This application claims priority to provisional application No. 60/927,552, the contents of which are incorporated herein by reference.

### BACKGROUND OF THE INVENTION

Wood and coal have been a principle source of fuel for hundreds of years. In modern times, petroleum has become a primary commodity for the generation of energy. Petroleum has had the advantages of relatively low cost and ease of transportation and storage because of its liquid consistency. Further, petroleum is readily amenable to fractionation and conversion into a variety of valuable industrial products such as fuels, building products, chemical intermediates and the like.

International developments have led to increase in the price of this crude oil. The consumption of petroleum has been increasing exponentially and concomitantly the readily available world petroleum supply has diminished. Governments and industrial concerns are dedicating increased attention to alternatives to petroleum as sources for fuels and chemical intermediates.

In recent years, the world has seen many innovations in “green” technologies, including methods for making synthetic fuels for transportation and heat utilizing the enzymatic and bacterial decomposition of cellulose and starch material to ethanol or similar alkanol products. Vegetable oils of many varied plant sources have been converted to alkyl esters. While these processes are clean and environmental friendly and can provide an alternative source of synthetic fuel, the use of edible plants inevitably leads to the increase of price for food supply. Moreover, many of these plants require high energy costs during the planting, harvesting and processing phases.

New programs are being developed for the provision of carbonaceous fuel products which complement and enhance conventional petroleum or coal-derived energy sources. Processes for liquefying coal or the gasification and then condensation of other carbon-containing materials have been proposed. However, these processes have not been deemed to be fully satisfactory for various cost or environmental reasons. There remains a pressing need for new technology that can deliver high quality fuels at economically and environmentally favorable levels, while maintaining atmospheric carbon neutrality.

Accordingly, it is desirable to provide a system and process of producing liquid synthetic fuels that overcomes drawbacks of conventional systems and methods of producing synthetic fuel.

Other objects and advantages of the present invention shall become apparent from the accompanying description and examples.

### SUMMARY OF THE INVENTION

Generally speaking, in accordance with the invention, a system and method for producing synthetic fuels, especially those that are essentially chemically identical to conventional vehicle fuels, is provided in which a feedstock containing polymers from a wide variety of sources is re-formed into a more satisfactory fuel source for producing heat, electricity, powering vehicles and the like. The feedstock can comprise scrap rubber, plastic and/or organic matter or other materials that are not particularly well suited for use as fuels in their existing state. The system and method can involve breaking relatively long polymer hydrocarbon and/or carbohydrate polymer molecules into shorter chain hydrocarbon radicals and then polymerizing the short chain hydrocarbons and forming a fuel comprising hydrocarbons of selected length. Reactors in accordance with preferred embodiments of the invention do not involve adding oxygen to the system and can be considered anaerobic. Reactions in accordance with preferred embodiments of the invention involve much less water than many conventional methods and can be considered relatively anhydrous.

Processes in accordance with preferred embodiments of the invention can involve physical reduction of the size of the various components; drying or wetting components to controlled water levels; liquefying reactions where components are broken down into shorter molecules; removal of oxygen atoms from carbohydrates and/or unsaturated bonds from hydrocarbon monomers; and recombination of short chain hydrocarbon monomers to desired molecular lengths to make synthetic fuels.

Feedstocks in accordance with the invention can include a wide variety of sources of cellulose. These can include various biomass sources, including wood chips, sawdust, brush, hay, straw, switch grass, corn stalks, kudzu and other sources of cellulose material. The sources of cellulose can be permitted to dry or actively dried to a selected moisture content. They can also be blended to result in desired moisture content. If necessary, water can be added to overly dry feedstocks. These sources of cellulose material can be blended with other polymer feedstocks, different types of cellulose or used as a single uniform type of cellulose.

The process can also involve the use of hydrocarbon polymers as a feed source. For example, waste plastic and rubber, such as used automobile tires can be used as a feedstock source. Mixtures of waste polymers with cellulose material are also acceptable for use as the feedstock. Tires can include all of the polymers now used to manufacture tires, such as butadienes and fillers, such as carbon, silica, aluminum and zinc acetate.

In one preferred embodiment of the invention, a feedstock is reduced in size, into particles that are preferably less than about 1,000 microns, more preferably less than about 500 microns and most preferably less than about 300 microns. This can be done in multiple stages with the final reductions in size preferably done with the feedstock in a slurry. The liquid for the slurry is preferably recycled hydrocarbon fuel product from the synthetic fuel process.

In one preferred embodiment of the invention, the polymer feedstock is combined with metals, such as Group VIII, IB, IIB, IIIA, IVA metals or in particular, platinum, iron, aluminum, zinc, copper and so forth. The metals can be provided as metal powders with substantially all, but at least 80% of which have a diameter of less than about 1000 microns, preferably less than about 500 microns, more preferably about 300 microns or less.

The feedstock should be subjected to the controlled application of high temperature and pressure to liquefy the feedstock. High temperature and pressure can be used to help break feedstock polymer molecules into short chain radicals, preferably 3, 6 and 9 carbon hydrocarbon radicals in accordance with the invention. Most, if not all of the original oxygen should be removed. The short chain hydrocarbons are advantageously combined into hydrocarbons of selected carbon chain length.

Processes in accordance with the invention are preferably conducted in substantially airtight conditions. It is preferred to put the feedstock into a non-aqueous slurry, with the liquid phase comprising mostly a hydrocarbon solvent. This phase should, however, while mostly comprising organic solvent, contain controlled amounts of water. The water can act as a source of hydrogen for aiding the reduction of molecular size. Water content is preferably about 25% to 5%, more preferably about 15% to 20% and most preferably about 16%-17%.

A preferred source of the metal powder comes from ground up automobile tires. Conventional automobile tires include steel belts. These belts are commonly formed from iron wire that is coated with copper, which in turn, may be coated with zinc. In a preferred embodiment of the invention, essentially all, but at least 80% of the tires are ground into smaller pieces, preferably in multiple stages, to a size less than about 1,000 microns, preferably less than about 500 microns and most preferably about 300 microns or less. This results in the production of metal particles in the above sizes. The final size reductions advantageously take place in a slurry.

In a preferred embodiment of the invention, the chemical reactions take place in an organic liquid phase. The hydrocarbon output of reactions in accordance with the invention can be recycled and use as the organic liquid, such as that combined with the initial feedstock, to ensure a substantially air free system and to assist in the downsizing of the feedstock solids. The recycled hydrocarbon output is at elevated temperature. Thus, the recycled stream aids in the initial elevation of feedstock temperature and reduces instances of charring. Recycling the output can also lead to branched chain hydrocarbons, which tend to increase octane or cetane ratings.

The invention can be run with multiple reactors, with three as a preferred number. In a first reactor, the feedstock can be substantially, at least about 80%, liquefied. This can involve breaking intermolecular bonds and reducing the size of the feedstock molecules and polymers. The output temperature is between about 250° F. to 450° F. In a second reactor, additional bonds are advantageously broken and the feedstock material can be transformed into shorter chain radicals. Dehydration takes place to replace hydroxyl groups with hydrogen. The output temperature is about 500° F. Finally, those radicals can be formed into polymerized hydrocarbons of selected length in the third reactor, the output temperature of which is about 700° F. to about 850° F.

Preferred reactors are in the form of horizontal tubes. The tubes are preferably formed of steel. The tubes are capable of containing liquid at over 700° F. and 500 psig. An internal screw is used to move the reactants in plug-flow, through the reactor at controlled speeds. Electrical heating elements on the reactor surfaces advantageously control the temperature of the reactors. Measuring the temperature and viscosity at the output can provide valuable feedback for controlling the heating elements and screw speed.

It is the believed that the metal powders in the slurry react with the water in the feed stream to yield metal oxides and hydrogen. At the temperatures involved, ranging from over about 250° F. to 450° F. and above, the free hydrogen is believed to attack bonds in the feed material and thereby reduce the size of the feedstock molecules and promote the liquefication of the feed stream. Increasing the temperature, either in the same or in a separate reactor, further breaks down the feed material into small chain hydrocarbon radicals, advantageously 3, 6, and 9 carbons in length. Molecular size can be adjusted by controlling the temperature, reactor time and the amount of metal added. As the reaction proceeds, the metal powder can be substantially converted into sufficient oxide powder to act as a surface catalyst for the polymerization of the short chain hydrocarbon radicals into hydrocarbons of selected lengths. By adjusting reaction temperatures, at least 80% if not substantially all of the output can be gasoline, diesel fuel or aircraft fuel. Alternatively, the output can be refined (or otherwise purified or separated) to one of these fuels. In another embodiment of the invention, the output can be blended as more than least 5% or 10% with one of these fuels. The resulting product can be used as is or further refined or purified. It can also be advisable to employ a mechanism, such as a shockwave producer, to break up any relatively long chain hydrocarbons, such as waxes, that might be in the final product.

The invention accordingly comprises the several steps and the relation of one or more of such steps with respect to each of the others, the system embodying features of construction, combinations and arrangement of parts which are adapted to effect such steps, and the product which possesses the characteristics, properties, and relation of constituents (components), all as exemplified in the detailed disclosure hereinafter set forth, and the scope of the invention will be indicated in the claims.

### DESCRIPTION OF THE DRAWINGS

For a fuller understanding of the invention, reference is had to the following description, taken in connection with the accompanying drawings, in which:

FIG. 1 is a schematic diagram of a system for producing synthetic fuels, in accordance with preferred embodiments of the invention;

FIG. 2 is a schematic diagram of a size reduction section of the system of FIG. 1;

FIG. 3 is a schematic diagram of a reaction section of the system of FIG. 1;

FIG. 4 is a schematic diagram of a finishing section of the system of FIG. 1;

FIG. 5 is a chemical drawing of the chemical breakdown of cellulose to aldotriose and/or aldohexose; and

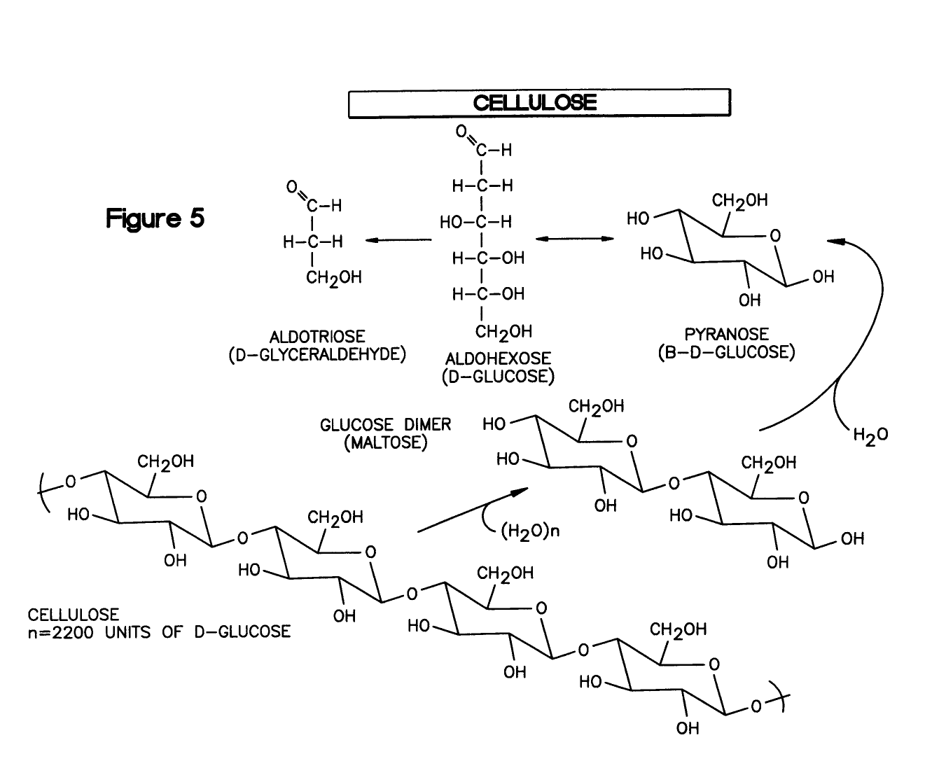

FIG. 6 is a chemical drawing of bond cleavage when butadiene containing tires are used.

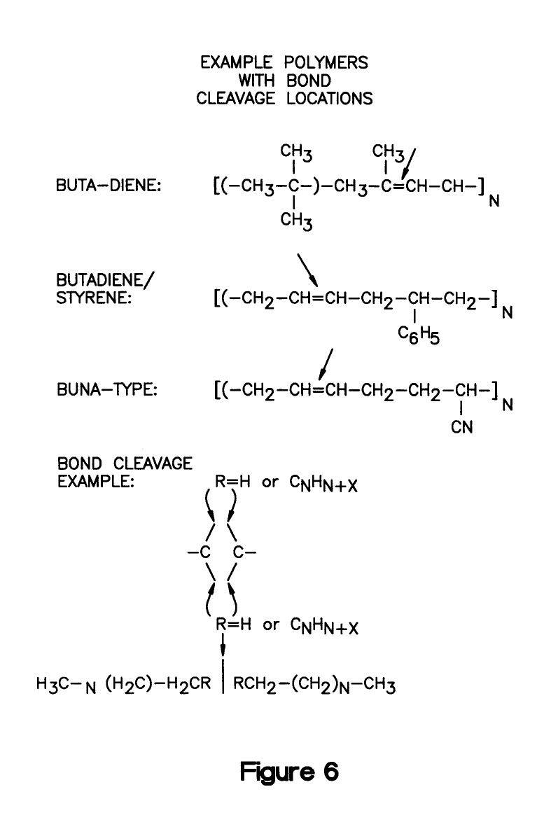

### DETAILED DESCRIPTION OF THE PREFERRED EMBODIMENTS

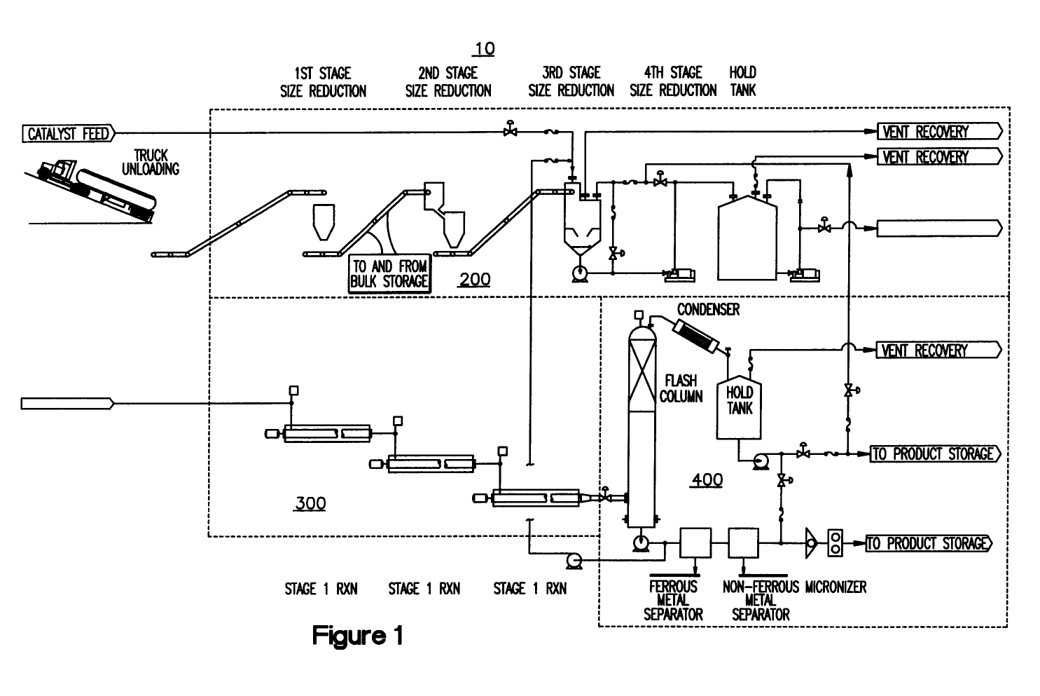

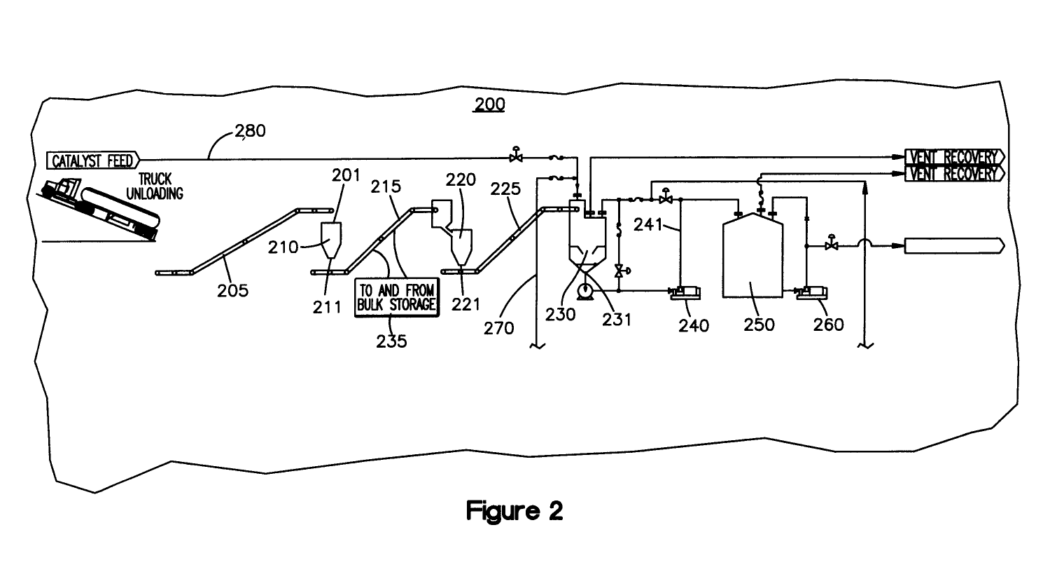

FIG. 1 is a schematic view of a fuel production plant 10 in accordance with a preferred embodiment of the invention. Plant 10 comprises three general process sections: a size reduction section 200, a reaction section 300 and a finishing section 400, each shown in greater detail in FIGS. 2, 3 and 4, respectively.

A preferred embodiment of the invention comprises a size reduction step having multiple stages to gradually reduce the size of the feedstock to the desired particle size. Referring to FIG. 2, size reduction section 200 preferably comprises a first stage size reduction grinder 210, a second stage size reduction grinder 220, a third stage size reduction grinder 230, a fourth stage size reduction safety grinder 240 and a slurry storage tank 250. Acceptable grinders in accordance with preferred embodiments of the invention include the MultiShear and Arde Barinco brand grinders, from MultiShear Corporation of Graniteville, S.C. and Arde Barinco, Inc. of Norwood, N.J.

A size reduction process begins when a truck or other vehicle delivers a variety of feedstock to plant 10 or when the materials are reduced in size off site. A feedstock 201 is placed on a first conveyor belt 205, which carries the feedstock upon unloading to first stage size reduction grinder 210. The output of first stage size reduction grinder 210 is placed on a second conveyor belt 215, which carries once-reduced feedstock 211 to second stage size reduction grinder 220. Similarly, the twice-reduced output 221 of second stage size reduction grinder 220 is placed on a third conveyor belt 225 and transported to third stage size reduction grinder 230. Optionally, a storage tank, such as tank 235, can be added to store once-reduced output 211 of first stage size reduction grinder 210 or twice-reduced output 221 of second stage size reduction grinder 220. The three times reduced output 231 from third stage size reduction grinder 230 can be fed into fourth stage size reduction safety grinder 240 to insure substantially complete size reduction before a slurry output 241 is being stored in slurry storage tank 250. Alternatively, output 231 can be stored in slurry storage tank 250 without being fed into fourth stage size reduction safety grinder 240.

Safety grinder 240 is optionally attached to slurry storage tank 250 to ensure uniformity particles of less than about 300 microns before the slurry enters reaction section 300.

A wide variety of synthetic polymer or cellulosic materials, including rubber, plastic, trees, bushes, brush, bark, sawdust, wood chips, hay, straw, switch grass field stubble and the like can be used as feedstock in accordance with the invention. However, certain materials require additional attention. For instance, bark can be used. However, because bark is high in ash and absorbs water readily, when using bark as feedstock, special attention needs to be paid to insure moisture content. Similarly, while pine saw dust can be used, it is recommended to limit the weight of pine saw dust used at less than 25% of the total feedstock weight.

An important purpose of the size reduction process of section 200 is to gradually decrease the size of the feedstock to desirable sizes, preferably less than 300 microns. In one embodiment, the feedstock is first ground to ½ inch to 1 inch pieces in first stage size reduction grinder 210, then to ⅛ inch to ⅜ inch size particles in second stage size reduction grinder 220 before entering third stage size reduction grinder 230. Both first and second stage grinders 210, 220 can be operated while the feedstock remains dry. In contrast, twice-reduced feedstock 221 is preferably combined with liquid to form a slurry form when it enters third stage grinder 230 and fourth stage safety grinder 240.

One important aspect of the invention is the moisture content of the feedstock. The moisture content of the feedstock can be controlled and adjusted before or after the feedstock enters the first or second stage size reduction grinders 210, 220. Feedstock of various moisture contents can be blended to achieve desirable average moisture content. If necessary, additional water can be sprayed or otherwise added into the system. Feedstock such as grasses, brush and wood chips can be permitted to dry before entering a process in accordance with the invention. Regardless of when the feedstock is dried, the average water content is preferably about 5-25%, more preferably about 15-20% and most preferably about 16-17%.

In accordance with embodiments of the invention shown in FIG. 2, third stage grinder 230 can be constructed and arranged to receive output 221 from second stage grinder 220 and, in addition, two additional feeds, including a liquid feed 270 and an initiator feed 280. All the inputs to third stage grinder 230 should be mixed to form a slurry 231 of the above-identified water content.

The input from liquid feed 270 advantageously comprises a non-aqueous hydrocarbon solvent 271. In one preferred embodiment of the invention, the hydrocarbon solvent can be final output 421 of plant 10. However, it is not necessary to use a recycle of the final product, and other hydrocarbon solvents can be used. Liquid feed 270 advantageously changes the viscosity of slurry 231. The addition of hydrocarbon solvent 271 fills out the available space in reactors discussed below to ensure an oxygen free enviromnent. It also makes size reduction easier.

Initiator feed 280 introduces initiator/catalyst particles 281 to the input of third stage grinder 230. Initiators can include elements of Group IB, IIB, IIIB, IVA, VB, VIB, VIIB and Group VIII. Preferred initiators include Group IB, IIB and VIII metals. Preferred examples include platinum, iron, aluminum, aluminum silica, zinc and copper. The initiator can be provided as pure metal powders. Alternatively, polymeric materials, such as used tires, can be used to provide the metal initiator. The steel belts in tires contain iron which can be coated with copper and/or zinc. The synthetic rubber itself includes aluminum and silica materials. All the metals in the tire can serve as initiators.

Initiator 281 is added to third stage grinder 230. Regardless of the source of initiator 281, it should have a particle size less than about 1000 microns, preferably less than 400 microns and more preferably about 300 microns or less. The smaller size can lead to a more optimal reaction rate because of the increased surface area. Initiator 281 should comprise more than 1% by weight of feedstock 201, preferably more than 3% and most preferably 5% or more.

Once feedstock 201 has undergone reduction, the slurry output 231 is fed into slurry storage tank 250 awaiting to be utilized in a chemical reaction process in reaction section 300.

Preferred embodiments of the invention comprise a reaction section 300. Preferred processes can involve multiple reaction stages in multiple reactors (2, 3, 4 or more) to break down feedstock into short chain carbon radicals. Those radicals, preferably 3, 6 or 9 carbon chains, repolymerize to form a burnable synthetic fuel as a final output 421 of plant 10. Such fuels can be prepared to be identical to conventional vehicle fuels refined from crude oil.

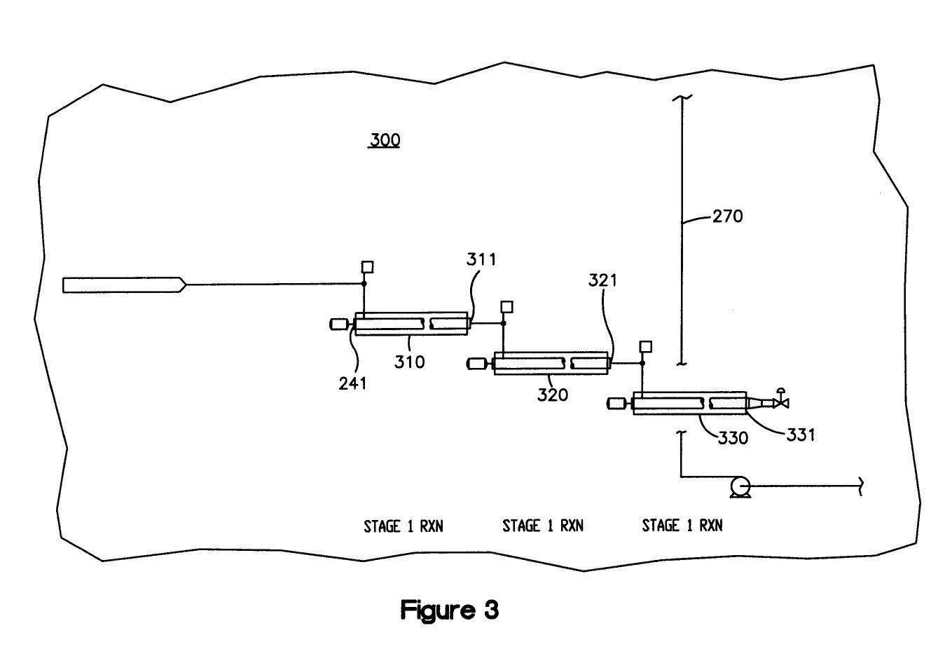

Referring to FIG. 3, reaction section 300 preferably comprises a first reactor 310, a second reactor 320 and a third reactor 330 linked in series. Optional systems and methods can involve fewer or more reactors. Each reactor is preferably in the form of a horizontal tube. Preferred sizes are about 30 feet in length with a 2½ foot inside diameter. Lengths and diameters of the reactors will vary depending on plant production capacity. However, a length to diameter ratio of 5:20 to 9:12, is acceptable with about 8:15 preferred. An internal screw (auger) is used to move the reactants in plug-flow, through the reactor at controlled speeds. The screw is of a variable speed so that time of plug flow through the reactor can be adjusted despite changes in flow volume and reaction rates. Electrical heating elements on the reactor surfaces advantageously control the temperature inside the reactors, allowing a gradual and uniform rise in temperature across the length of the reactor. Viscosity is generally proportional to molecular size. Thus, viscosity measurements are advantageously taken at the output of each reactor and analyzed, in order to adjust the heating elements and screw speed, to provide the optimal reaction time, temperature and pressure. Temperature can be measured at the input, output and at intermediate points. The viscosity measurements can be used to affect the heating elements and screw speeds to adjust residence times and reactor temperature as needed. The reactants can spend between 10 to 15 minutes, preferably a residence time of about 11-13 minutes in each reactor.

Each reactor should be sealed off from the atmosphere and pressurized to ensure an anaerobic reaction with no added atmospheric oxygen. However, the pressure in each reactor need not be specifically controlled. Rather, pressure can be the result of the increase in temperature. Because of the lack of oxygen and the ability to control surface temperature of the reactors, there is relatively negligible char build-up after reactions to require extensive and frequent cleaning. In addition, the auger tends to provide a constant cleaning function.

The goal of first reactor 310 and second reactor 320 is to liquefy and break down the feedstock to short chain monomers and monomer radicals. In one embodiment of the invention, to begin reaction, slurry output 241 is heated to about 250° F. at a pressure of about 100 psig and fed into first reactor 310. The temperature increase can be achieved in various ways, preferably by recycling hot liquid or slurry streams from other parts of plant 10. While in first reactor 310, the temperature of the reactants continues to rise, resulting in a liquefied output 311 with the temperature about 450-500° F. at a pressure about 500 psig. During the residence time in first reactor 310, various solids of slurry output 241 are liquefied by the increasing temperature and pressure. Speed and temperature should be adjusted so that no more than a trace of non-liquid material leaves first reactor 310.

Second reactor 320 is constructed and set up in a similar fashion as first reactor 310. Liquefied output 311 from first reactor 310 enters second reactor 320 at about 450° F. and a pressure at about 500 psig. Generally, unlike the endothermic reaction in first reactor 310, because the reaction in second reactor 320 is typically exothermic, no additional heat is needed except for the purpose of maintaining constant temperature and controlling reaction rate.

It is believed that while in first reactor 310, as the temperature increases from about 250° F. to 450° F., initiator 281 begins to react with available water in the feedstock to become oxidized by freeing hydrogen in water, creating free hydrogen. The free hydrogen, along with high temperature and pressure, liquefy solids in slurry output 241 by attacking the double bonds in hydrocarbon polymers and weak covalent bonds in cellulosic materials to make shorter chain molecules and promote the liquefication of the feed stream. When carbon-carbon bonds are cleaved, more hydrogen is produced. About 50-70% of the breakdown of plastic and cellulosic materials to short chain molecules can occur in first reactor 310.

### Reforming:

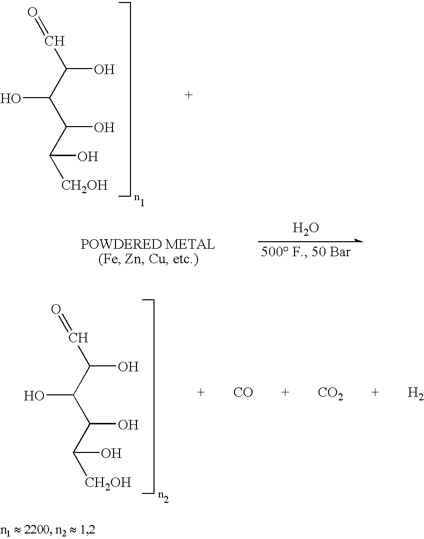

Once liquefied output 311 enters second reactor 320, components are believed to continue to be broken down into short molecular links and further into intermediates through the process of dehydration on the surface of initiator 281. The length of carbon chains can be altered and controlled by changing the temperature, reactor residence time and amounts of initiator 281 added. The free hydrogen created in reactor 310 is believed to react with dehydration intermediates to replace hydroxyl groups with hydrogen to form alkyl hydrocarbon radicals. These hydrocarbon radicals, preferably 3, 6, 9 carbon in length are believed to be weakly bonded to the surface of initiator 281 with unsaturated double bonds, readily available for polymerization while the oxygen from the hydroxyl groups continue to oxidize initiator 281. Some oxygen reacts with free hydrogen to form water. Some traces of alcohols such as ethanol and methanol are also formed.

### Dehydration:

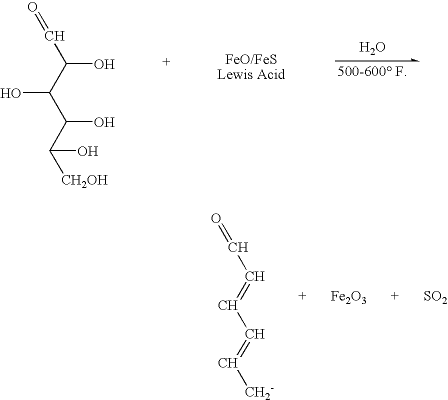

### Hydrogenation:

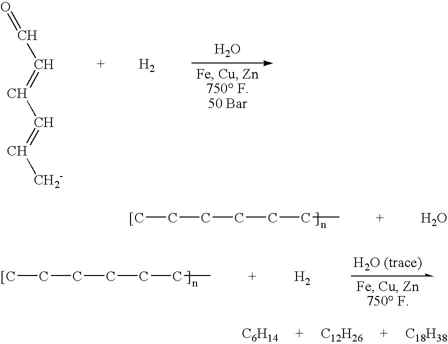

The series of reformation, dehydration and hydrogenation are self-activating because of the derivative intermediates formed. As long as the surface area of initiator 281 plus the temperature and pressure are maintained in an optimum balance, the cycle of reformation, dehydration and hydrogenation continue to replicate. Furthermore, dehydration and hydrogenation are both self-sustaining steps because they are exothermic reactions.

An output 321 of second reactor 320, typically comprising short chain hydrocarbon radicals as well as substantially oxidized initiator 281, exits second reactor 320 at about 650° F. and about 700 psig after a residence time of about 10-12 minutes in second reactor 320. The exothermic effect of dehydrogenation provides heat to be recycled to first reactor 310 to raise the temperature of slurry output 241 from storage take 250.

Head-to-tail polymerization of short chain carbon radicals is understood to begin automatically in third reactor 330 as temperature is raised up to between 700°-800° F. At this point in the reaction, initiator 281 should be converted to a sufficiently high oxidation state or fully oxidized to become inactive as to attack bonds to create free hydrogen as experienced in first reactor 310. However, oxidized initiator particles continue to provide surface sites for the polymerization of the short chain hydrocarbon radicals into hydrocarbons of selected lengths. The length of the carbon chain of the polymers can be controlled by adjusting the residence time and temperature of third reactor 330. For example, to produce gasoline, shorter molecules of 6-12 carbon atoms are best. For diesel duel, 12-21 carbon molecules and for aircraft fuel, 15-19 carbon molecules are preferred.

It would be within the skill of the art to adjust time, temperature and pressure in the three reactors to adjust the output as desired. In any event, for diesel fuel, polymerization in the 700-800° F. range; gasoline, 800-850° F. and kerosene, 750-850° F. should be acceptable. The polymerization takes place at a very high temperature. Dropping the temperature lowers and stops the rate of polymerization. Some co-polymerization and branched polymerization can also occur. This can be enhanced by recycling the output. This leads to enhanced octane ratings.

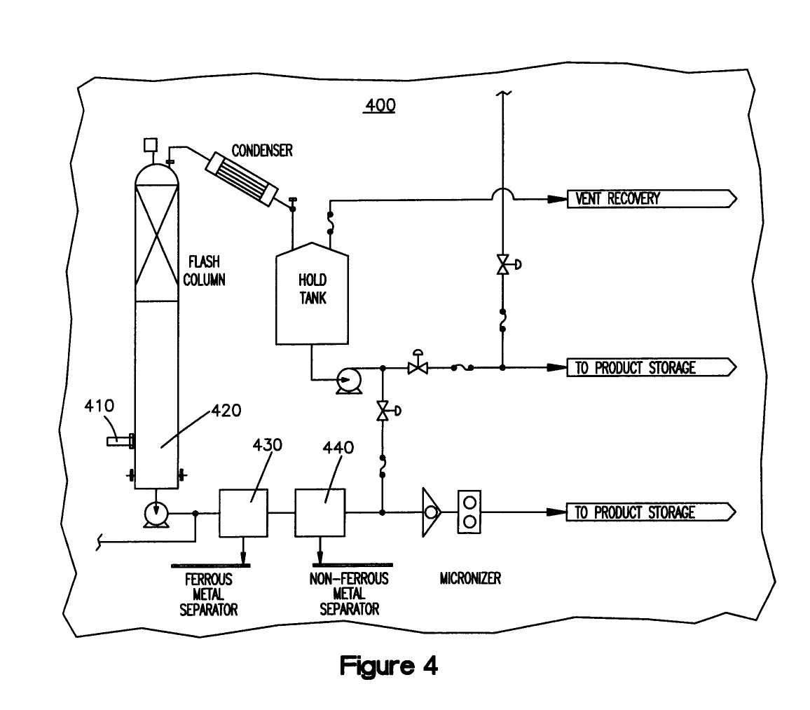

When the desired polymerization has occurred, the content of third reactor 330, a polymerized output 331, is fed into a flash column 420 shown more clearly as part of final section 400 in FIG. 4. Optionally, before polymerized output 331 enters flash column 410, a shock wave device 410 can be employed to use shock waves to break up long chain polymers into shorter chain polymers. Shock wave device 410 operates at high temperatures and sends sonic waves to break up long molecular chains. Acceptable shock wave devices are available from Seepex, Inc. of Enon, Ohio. In the present invention, shock wave device 410 helps break up any wax and other 25-30 carbon chain alkynes into shorter chain molecules.

As the pressurized polymerized output 331 enters flash column 420, the pressure is reduced from 800 psig to 200 psig while the temperature is lowered to about 400° F. The decrease in temperature ends polymerization. Within flash column 420, lighter carbon chains, such as those with fewer than 12 carbons, are understood to vaporize, can be collected through a vent and can be condensed through a condenser 430 as a fuel source such as gasoline. In the production of diesel fuel, 6 to 8% of polymerized output 331 is understood to vaporize in flash column 420. Traces of carbon dioxide and carbon monoxide are also vented off at this time. They can be collected or processed, if it is desired, to reduce greenhouse emissions. Carbon chains with more than 12 carbons tend to stay in liquid phase and can be collected as a final output fuel 421. Final output fuel 421 is advantageously recycled as input to liquid feed 270 to serve as the required non-aqueous hydrocarbon solvent.

Typically, the weight of final output fuel 421 recycled and the weight of solid feedstock 201 input into size reduction section 200 of plant 10 should have about a 1 to 1 to a 1 to 2 ratio. Recycled final output fuel 421 acts a as heat source and provides initiators 281 to the feedstock stream.

In a preferred embodiment, a ferrous metal separator 430 and a non-ferrous metal separator 440 are utilized to remove and recycle initiators 281. Ferrous metal separator 430 can be assembled as a magnetic system that captures any iron or iron oxides in final output 421. The collected iron particles can be reduced back to their metallic form to be reused in the invention again, or sold as scrap. Non-ferrous metal separator 440 is a pressure filter type separator. Once separated, these non-ferrous metal particles can be washed and sold to the fertilizer industry.

Preferred embodiments of the invention will be illustrated with reference to the following examples, which are presented by way of illustration only and should not be construed as limiting.

### EXAMPLE I

| | |
|---|---|
| Feedstock | 75 g (30% wood, 30% hay, 15% switch |
| | grass, 25% styrene/butadiene polymeric |
| | plastic) |
| Feedstock particle size | <300 microns |
| Moisture content | 15% |
| Initiator | 25 g of iron (Fe) |
| Initiator particle size | <300 microns |
| Solvent | Mixture of organic liquids (alkanes of |
| | carbon number C₅ to C₂₁) |
| Polymerization temperature | 700-800° F. |
| Polymerization duration | 3-20 minutes |
| Product | 95% C₃ to C₂₁ molecules, 5% carbon |
| | number greater than 21 |

### EXAMPLE II

| | |
|---|---|
| Feedstock | 100 g of pure wood cellulose |
| Feedstock particle size | 500 microns or less |
| Moisture content | 20% |
| Imitator | 10 g of copper (Cu) and 10 g of zinc (Zn) |
| Initiator particle size | <200 microns |
| Solvent | 100 g of diesel fuel |
| Polymerization temperature | 600° F. |
| Polymerization duration | 10 minutes |
| Product | 93% C₆ to C₁₂ alkanes and alkanols, 7% |
| | C₁₂ to C₂₁ alkanes and alkanols |

### EXAMPLE III

| | |
|---|---|
| Feedstock | 100 g of hay |
| Feedstock particle size | <100 microns |
| Moisture content | 7% |
| Imitator | 5 g of platinum (Pt) |
| Initiator particle size | <100 microns |
| Solvent | 100 g of combined liquid products of |
| | Example I and Example II |
| Polymerization temperature | 850° F. |
| Polymerization duration | 15 minutes |
| Product | 94% C₆ to C₁₂ alkanes and alkanols, 6% |
| | C₁₂ to C₁₈ alkanes and alkanols |

The above examples show the variety of feedstocks that can be used in the system to produce different synthetic fuels in accordance with the invention. The type of synthetic fuel produced can be controlled by the type of initiator used as well as reaction conditions such as those within third reactor 330. It is understood that in first and second reactors 310, 320, the feedstock is substantially liquefied by breaking intermolecular bonds using increased temperature and the reaction between the water and metal catalyst initiators. Feedstock is broken into short chain hydrocarbon radicals, ready to combine with others and polymerize. In third reactor 330, the radicals automatically polymerize as the temperature and pressure are increased to optimize the reaction rate. At this point, initiators that played a significant role in creating hydrogen that attacks and breaks intermolecular bonds have transformed from highly active chemical initiators to highly oxidized and therefore active surface catalysts that provide surface sites for polymerization. The initiators serve different purposes in the reformation, dehydration, rehydrogenation and polymerization reactions in the various reactors as their oxidation state alters with the reaction.

Below is a summary of product that can be produced using a blend of tire chips, wood chips and straws after running the entire system for 24 hours. Runs 1 to 7 use iron and initiator/catalysts from tires (copper, zinc, silica, aluminum) to initiate and further reactions. Instead of using tires as a source of initiators, runs 8, 9 and 10 use pure metal powder comprising 90% iron and 10% copper. Runs 11 to 13, also use metal powder at the ratio of 90% iron, 5% silica and 5% aluminum. The polymerization times are listed, as well as temperature and pressure during polymerization.

| | Runs | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| Polymerization time | 12 | 12 | 12 | 12 | 12 | 8 | 13 | 8 | 10 | 12 | 6 | 8 | 10 |
| (min) | | | | | | | | | | | | | |
| Polymerization | 500 | 600 | 700 | 750 | 800 | 800 | 600 | 500 | 750 | 850 | 500 | 700 | 850 |
| temperature (° F.) | | | | | | | | | | | | | |
| Polymerization | 20 | 25 | 30 | 40 | 50 | 50 | 30 | 40 | 45 | 50 | 30 | 40 | 50 |
| pressure (atm) | | | | | | | | | | | | | |

Product Analysis %

| | 1 | 2 | 3 | 4 | 5 | 6 | 7 | 8 | 9 | 10 | 11 | 12 | 13 |
|---|---|---|---|---|---|---|---|---|---|---|---|---|---|
| C1 | — | <.5 | 1 | 1 | 2 | — | — | — | — | 1 | — | Trace | 4 |
| C2 | — | <.5 | 3 | 4 | 4 | — | — | — | — | 1 | — | Trace | 4 |
| C3 | — | — | 3 | 3 | 4 | 1 | — | — | — | 2 | — | 4 | 3 |
| C4 | 2 | 3 | 3 | 3 | 3 | 3 | — | <1 | 1 | 2 | — | 4 | 4 |
| C5 | — | <1 | <1 | 1 | 3 | 1 | 3 | <1 | 1 | 9 | 2 | 3 | 6 |
| C6 | 2 | 3 | 5 | 5 | 8 | — | — | 1 | 2 | 20 | 2 | 3 | 11 |
| C8 | 2 | 2 | 2 | 26 | 20 | 2 | 9 | 1 | 2 | 23 | 1 | 13 | 26 |
| C10 | 4 | 6 | 18 | 25 | 21 | — | — | 3 | 1 | 31 | 1 | 11 | 23 |
| C12 | 39 | 61 | 52 | 20 | 33 | 35 | 27 | 13 | 14 | 6 | 24 | 19 | 13 |
| C14 | 10 | 17 | 9 | 6 | — | 5 | 11 | 21 | 21 | 2 | 12 | 17 | 3 |
| C16 | 13 | 1 | 2 | 2 | 1 | 17 | 10 | 24 | 21 | 1 | 12 | 18 | 1 |
| C18 | 18 | 1 | — | 1 | 1 | 19 | 26 | 14 | 14 | 1 | 32 | 9 | <1 |
| C20 | 5 | <1 | 1 | 1 | — | 9 | 21 | 10 | 14 | — | 10 | 4 | <1 |
| C22 | 4 | 3 | — | 1 | — | 9 | 1 | 10 | 8 | — | 3 | 1 | — |
| C24 | 1 | — | — | 1 | — | 4 | — | 1 | 1 | 1 | 1 | 4 | — |

As discussed herein, a system and method are provided for converting cellulosic and plastic materials into synthetic form of gasoline, diesel, kerosene and home heating fuel. This can be achieved by using non-food related cellulosic and plastic material to generate transportation fuels. Polymeric raw material is depolymerized to a low molecular weight intermediate and then re-polymerized to a controlled molecular weight, which is similar to the molecular structures of gasoline or diesel.

The invention involves a proprietary process that can convert tires, plastics and biomass materials into synthetic fuels by breaking down cellulose and hemicellulose into short chain monomer molecules and recombining these monomers into synthetic gasoline, diesel fuel and jet fuel, among other products. The process combines pressure, heat and chemical catalysts. Specifically, the process combines the following general steps: (i) size reduction process that reduces feedstock materials to a low-micron level particle; (ii) liquefication reactor system which reduces the feedstock to short chain monomers; (iii) second stage processing system which recombines the monomers into synthetic gasoline (based on a 6-12 carbon chain molecule), diesel fuel (based on a 12-21 carbon chain molecule), or jet fuel (based on a 12-18 carbon chain molecule); and (iv) transfer and storage tanks for final products. Processes and systems in accordance with the invention can be used to produce one gallon of synthetic fuel from about 12 to 15 pounds of dry cellulose or plastic polymer.

The process may be highly environmentally friendly. The process can be anaerobic and anhydrous (non-aqueous carrier liquid) which crates negligible amounts of carbon dioxide, a major byproduct of many competing processes, and the anhydrous process generates no wastewater.

Fuels produced can have boiling points of 3000 to 700° F., room temperature viscosities of 1-200 cp and can be suitable for a variety of uses.

It will thus be seen that the objects set forth above, among those made apparent from the preceding description, are efficiently attained and, since certain changes may be made in carrying out the above method in the constructions set forth without departing from the spirit and scope of the invention, it is intended that all matter contained in the above description and shown in the accompanying drawings shall be interpreted as illustrative and not in the limiting sense.

It is also to be understood that the following claims are intended to cover all of the generic and specific features of the invention herein described and all statements of the scope of the invention which, as a matter of language, might be said to fall therebetween.

Particularly it is to be understood that in said claims, ingredients or compounds recited in the singular are intended to include compatible mixtures of such ingredients wherever the sense permits.

What is claimed is:

1. A system for producing combustible fuels, comprising:
a feed stream containing a slurry of feedstock pieces, metal pieces and water in a non-aqueous carrier liquid;
a reactor section, having an input end receiving the feed stream and an output end outputting a reacted feed stream and comprising one or more reactor vessels;
the one or more reactor vessels constructed to cause the carrier liquid to flow through at least one reactor vessel in substantially plug flow at a controlled flow velocity and residence time within the one or more reactors;
the temperature on the inside surface of the reactor being raised progressively and in a controlled manner to over about 700° F., at least one reactor having a device to measure the viscosity and the temperature of the contents exiting the reactor and a device to adjust the temperature of the contents of the reactor and the time it takes the carrier liquid to flow through the reactor based on the viscosity measurement; and
the metal pieces and water input at the input end of the reaction section of sufficient quantity with respect to the feedstock particles to react and substantially turn the feedstock pieces into combustible liquid fuel at the output end of the reaction section.

2. The system of claim 1, wherein at least 80% of the feedstock pieces are particles smaller than about 500 microns in diameter.

3. The system of claim 1, wherein at least 80% of the feedstock pieces are particles smaller than about 300 microns in diameter.

4. The system of claim 1, wherein the feedstock pieces comprise cellulose.

5. The system of claim 1, wherein the carrier liquid is recycled liquid directly or indirectly from the output end of the reactor.

6. The system of claim 1, wherein the feedstock pieces comprises shredded tire particles, 80% or more of which have a particle diameter less than about 500 microns.

7. The system of claim 1, wherein the feedstock pieces comprises shredded tire particles, 80% or more of which have a particle diameter less than about 300 microns.

8. The system of claim 1, wherein the feedstock pieces comprise a combination of shredded tire particles and biomass.

9. The system of claim 1, wherein the reactor section comprises a first reactor vessel, at temperature and pressure conditions, wherein at least 80% of the feedstock pieces are liquefied because their polymer length is reduced compared to the length of the polymers in the particles entering the feed stream.

10. The system of claim 1, wherein the reactor section comprises a first reactor vessel, wherein the output temperature of the first reactor vessel is between 250° F. to 450° F.

11. The system of claim 1, comprising at least two reactor vessels in series, wherein a liquid output is flowing from the first of the two to the second of the two reactor vessels and the output temperature in the second vessel is over about 500° F.

12. The system of claim 11, wherein there are at least three reactor vessels in series and the third of the three receives the output of the second vessel and the temperature of liquid output from the third of the three vessels is about 700° F. to 850° F.

13. The system of claim 4, wherein the reactor section contains cellulose that underwent a dehydration reaction.

14. The system of claim 1, wherein the reaction section contains oxidized metal pieces.

15. The system of claim 1, comprising three reactions, wherein liquefaction of the feedstock pieces is occurring in the first reactor, feedstock polymer molecules are being broken off in the second reactor and polymerization into hydrocarbon is occurring in the third reactor.

16. A system for producing combustible fuel, comprising:
a feedstock stream comprising source particles of waste plastic, tires or organic matter that are formed from polymer molecules combined with a hydrocarbon-based carrier liquid, metal particles and water;
one or more reactors having input ends and output ends, at least some of the reactors having electrical heat controls and internal augers.

17. A reactor designed to produce liquid hydrocarbon fuel, comprising:
a non-vertical tube with a length to width ratio of about 5:20 to 9:12, the tube having electrical heating elements and an internal auger, the tube capable of containing liquids at over 700° F. and 500 psig.
